(19) United States
(12) Patent Application Publication
(10) Pub. No.: US 2026/0035275 A1
(43) Pub. Date: Feb. 5, 2026

(54) RECOVERY AND RECYCLE OF A CORROSION INHIBITOR FOR INDUSTRIAL WATER TREATMENT

(71) Applicant: CHEMTREAT, INC., Glen Allen, VA (US)

(72) Inventors: Patrick WOOD, Midlothian, VA (US); Santanu BANERJEE, Glen Allen, VA (US); William HENDERSON, Midlothian, VA (US); Rajendra Prasad KALAKODIMI, Glen Allen, VA (US)

(73) Assignee: CHEMTREAT, INC., Glen Allen, VA (US)

(21) Appl. No.: 19/237,621

(22) Filed: Jun. 13, 2025

Related U.S. Application Data
(60) Provisional application No. 63/677,556, filed on Jul. 31, 2024.

(51) Int. Cl. C02F 1/467; C02F 1/28; C02F 1/44; C02F 1/461; C02F 1/52; C02F 101/20; C02F 103/02

(52) U.S. Cl. CPC C02F 1/4672; C02F 1/28; C02F 1/44; C02F 1/46104; C02F 1/52; C02F 2101/20; C02F 2103/023; C02F 2201/005; C02F 2201/4613; C02F 2201/46135; C02F 2303/08; C02F 2303/18

(57) ABSTRACT

A method for recovering a corrosion inhibitor from a water system includes treating a water stream of the water system that includes the corrosion inhibitor to selectively recover the corrosion inhibitor from the water stream. The method may include introducing the recovered corrosion inhibitor back into the water system. The corrosion inhibitor may be selectively recovered by applying a predetermined voltage to the electrochemical system to change an oxidation state of the corrosion inhibitor, the predetermined voltage corresponding to an oxidation reduction potential of the corrosion inhibitor.

This nonprovisional application claims the benefit of U.S. Provisional Application No. 63/677,556, filed Jul. 31, 2024.

### BACKGROUND

Corrosion in industrial water systems is a serious problem. It causes undesirable consequences, including loss of heat transfer, increased cleaning frequency, equipment repairs and replacements, shutdowns, environmental problems, and increasing resources and costs associated with each.

Treatment of corrosion in water systems is typically achieved by the application of various corrosion inhibitors in the water, including, for example, tin, zinc, molybdenum, copper, and aluminum, amongst others. After one or more cycles through the system, the corrosion inhibitor can be gradually removed from the system with the process water in the system, for example, through known blowdown removal techniques. Therefore, continuous or periodic treatment of corrosion inhibitors is typically applied to the water system.

However, continuous or periodic treatment of the water system with corrosion inhibitors can impact the effluent stream of the treated water systems and can result in toxicity issues, environmental concerns and/or additional costs associated with remedial treatment or enhanced handling of the effluent stream. For example, certain corrosion inhibitors, such as zinc, are regulated by governmental agencies, such as the U.S. Environmental Protection Agency (EPA). Ensuring compliance with such regulations can increase costs. In addition, the continuous or periodic application of corrosion inhibitor into the water may result in increased costs and efforts.

Accordingly, there is a need to capture and recycle components of the corrosion inhibitor composition from an industrial water system.

### SUMMARY

In one aspect, this disclosure provides a method and system for capturing and recycling components that reduce or eliminate these drawbacks.

In one aspect, this disclosure provides a method for recovering a corrosion inhibitor from a water system, the method comprising treating a water stream of the water system that includes the corrosion inhibitor to selectively recover the corrosion inhibitor from the water stream.

In another aspect, this disclosure provides a water system comprising at least one conduit through which a discharge stream flows, wherein the discharge stream is a water stream that has been treated with a corrosion inhibitor; and a corrosion inhibitor recovery system configured to: receive the discharge stream from the at least one conduit, and selectively recover the corrosion inhibitor from the discharge stream.

According to some embodiments, it is possible to recycle the corrosion inhibitor treatment or components thereof. An objective is to reduce costs of supplying corrosion inhibitor into the industrial water system and further decrease the environmental impact of releasing, for example, blowdown including the corrosion inhibitor treatment, into a body of water.

### BRIEF DESCRIPTION OF THE DRAWINGS

FIG. 1 is a schematic view of an industrial water cooling system;

FIG. 2 is a schematic view of an electrochemical system including electrodes for precipitation of a capture target;

FIG. 3 is a schematic view of an alternate embodiment of an industrial water cooling system; and

FIG. 4 is an example of a Pourbaix diagram.

### DETAILED DESCRIPTION OF EMBODIMENTS

In the following description, numerous details are set forth to provide an understanding of the present disclosure. However, it may be understood by those skilled in the art that the methods and systems of the present disclosure may be practiced without these details and that numerous variations or modifications from the described embodiments may be possible.

Disclosed embodiments will now be described with respect to exemplary embodiments of industrial processing systems, including cooling water treatment systems. It will be understood that it is not intended for this disclosure to be limited to these specific embodiments. Embodiments of the disclosed methods and systems apply to corrosion inhibition in water systems including but not limited to cooling towers, water distribution systems, boilers, pasteurizers, water and brine carrying pipelines, storage tanks, reverse osmosis processes, once-through cooling systems, and the like.

As used herein, water, water stream, and water supply, for example as used in a water system, are not particularly limited and may include, for example, any aqueous solution comprising at least 50%, 75%, 90%, 95% or 99% water.

### Water System

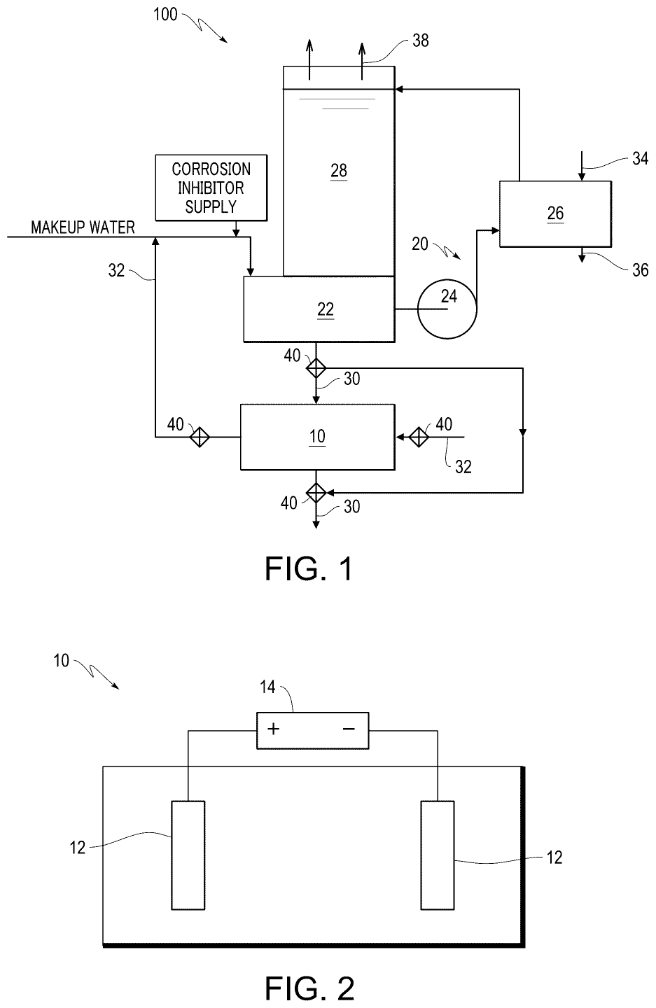

FIG. 1 depicts an embodiment of a cooling water treatment system 100. A process stream is fed along a flow path 20 from a sump 22, where the cooling water is stored. The flow path 20 is pumped through a heat exchanger 26 by a pump 24 and then enters an atmospheric cooling tower 28. The heat exchanger includes a cool water stream 34 and a hot water stream 36. After being cooled in the atmospheric cooling tower 28, the process stream may then re-enter the sump 22. As air passes through the atmospheric cooling tower 28, it induces evaporation 38.

Embodiments of the disclosure are not limited to atmospheric cooling towers and may include, for example, any industrial processing system such as water distribution systems, boilers, pasteurizers, water and brine carrying pipelines, storage tanks, reverse osmosis processes, and once-through cooling systems.

At least one conduit including a makeup stream 32 or a feedwater stream may periodically replenish the sump 22. In some embodiments, the makeup stream 32 may be a feed supply, for example, from a body of water. In some embodiments, the makeup stream 32 is configured to continuously feed water to the sump 22.

A corrosion inhibitor feed supply provides a corrosion inhibitor treatment to the makeup stream 32. In some embodiments, the makeup stream 32 may already include a corrosion inhibitor treatment or components thereof. A positioning of an injection site, which is configured to receive corrosion inhibitor treatment introduced into the cooling water treatment system 100, is not particularly limited. For example, the corrosion inhibitor feed supply may feed the corrosion inhibitor treatment directly into the flow path 20. The method and manner by which a corrosion inhibitor treatment is infused or injected into the makeup stream 32 or the flow path 20 is not particularly limited. Methods for infusing the corrosion inhibitor treatment, including controlling the flow of the infusion, may include a multi-valve system or the like, as would be understood by one of ordinary skill in the art.

Fluid from the sump 22 may be discharged along a discharge stream 30, for example, as blowdown. At the early stages of the treatment in a system with existing corrosion and/or exposed metal surfaces, a total inhibitor demand may be high but may decrease as metal surfaces are treated by the corrosion inhibitor treatment. A treatment end point is reached, for example, when all surfaces are treated and only the system (non-metal surface) demand remains. Once effective treatment is achieved, the system can be operated for extended periods without the need for any further addition of corrosion inhibitor or with a substantially reduced level of corrosion inhibitor. However, corrosion inhibitor initially provided may pass through the system, having not reacted with exposed metal surfaces. Further, additional corrosion inhibitor may be fed into the system to ensure the end point is reached. Thus, excess corrosion inhibitor tends to accumulate in a system and must be released, for example, through blowdown.

At least one conduit including a discharge stream 30 may be positioned on the sump 22. The discharge stream 30 may be a blowdown or a bleed stream, for example, configured to release excess corrosion inhibitor accumulated in the sump 22 or the cooling water treatment system 100. The positioning of the at least one conduit including the discharge stream 30 is not particularly limited. In some embodiments, the discharge stream 30 may be positioned on the flow path 20, for example after the heat exchanger 26 and before the fluid enters the atmospheric cooling tower 28. The discharge stream 30 may be released into, for example, an effluent stream.

### Capture System

A capture system may be positioned downstream of the corrosion inhibitor injection site at a capture site to capture corrosion inhibitor in the cooling water treatment system 100 or being released from the cooling water treatment system 100. For example, the capture system may be configured to receive a water stream that has been treated with the corrosion inhibitor by way of at least one conduit. The capture system may be configured to selectively recover and capture the corrosion inhibitor or a component thereof.

The selectively recovered corrosion inhibitor is not particularly limited and may be any compound, such as a metal or component in the corrosion inhibitor treatment. For example, the capture target may be at least one of tin, zinc, molybdenum, copper, and aluminum, Cerium, Lanthanum.

A mechanism of the capture system is not particularly limited and any suitable means of capturing the capture target may be utilized. For example, the method and/or mechanism of capture at the capture site may include but is not limited to chelating metal and precipitation, pH fluctuations, metal scavenger chemistry, adsorption through selective resin, activated carbon, clay, filtration, sedimentation and decantation, evaporation, and distillation.

The capture system may be an electrochemical capture system 10. In some embodiments, the electrochemical capture system 10 may be positioned on the discharge stream 30. In some embodiments, the capture target may be captured by the electrochemical capture system 10 and then the discharge stream 30 may be discharged from the electrochemical capture system 10. Alternatively, the discharge stream 30 may continuously flow through the electrochemical capture system 10.

FIG. 2 is a schematic view of an electrochemical capture system 10. The electrochemical capture system 10 includes at least one electrode 12. The discharge stream 30 may flow through the electrochemical capture system 10, for example, from blowdown discharged from the sump 22.

The electrochemical capture system 10 includes an electrochemical cell 14 which applies a voltage to the at least one electrode 12. As discussed herein, the at least one electrode 12 may include an anode and a cathode configured to selectively recover corrosion inhibitor in the electrochemical capture system 10, for example, by precipitation of the corrosion inhibitor. In some embodiments, the electrochemical capture system 10 may also release the corrosion inhibitor back into the water system.

The size, configuration, number, and composition of the at least one electrode 12 are not particularly limited. For example, parameters of the process stream, such as a pH, a composition, a temperature, or a flow velocity or parameters of the capture target may affect an ability of the at least one electrode 12 to capture/release the capture target or may affect deterioration of the at least one electrode 12 in the electrochemical capture system 10. Accordingly, the size, configuration, number, and composition of the at least one electrode 12 may be determined to increase the effectiveness of the electrochemical capture system 10 in capturing/releasing the capture target or to increase longevity of the at least one electrode 12.

Referring again to FIG. 1, valves 40 may be configured to regulate fluid communication between the electrochemical capture system 10 and makeup stream 32 and/or the discharge stream 30. For example, as depicted in FIG. 1, valves 40 may be activated to direct the discharge stream 30 into or through the electrochemical capture system 10. However, the discharge stream 30 need not flow into the electrochemical capture system 10. For example, the valves may shut off a supply of the discharge stream 30 to the electrochemical capture system 10 and direct the fluid around the electrochemical capture system 10.

In some embodiments, the capture target may be recycled into the cooling water treatment system 100 by way of redirecting flow of the process stream. For example, valves 40 may be activated to feed the makeup stream 32 into or through the electrochemical capture system 10. However, the makeup stream 32 need not flow through the electrochemical capture system 10 and may flow directly into the sump 22.

In some embodiments, a single valve 40 may regulate flow between the electrochemical capture system 10 and makeup stream 32 and/or the discharge stream 30. Alternatively, multiple valves 40 may be used.

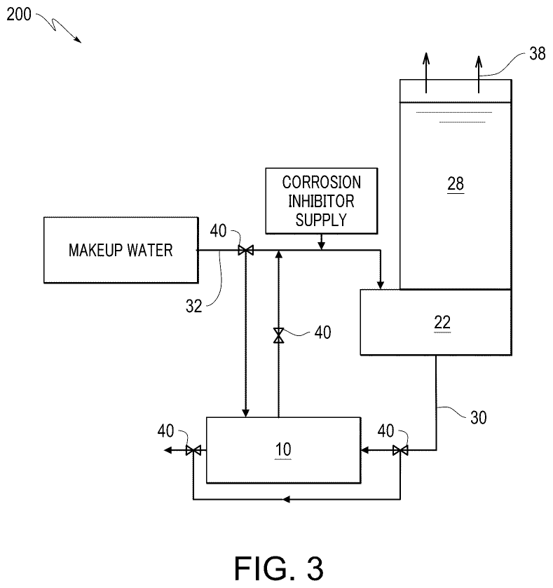

FIG. 3 is an alternate embodiment of a water system 200. Valves 40 may direct the makeup stream 32 to the electrochemical capture system 10. The electrochemical capture system 10 may release recovered corrosion inhibitor into the makeup stream 32, where it is supplied to the sump 22. Additional corrosion inhibitor may be injected into the makeup stream 32 before entering the sump 22. Alternatively, for example, when corrosion inhibitor is being recovered in the electrochemical capture system 10, the makeup stream 32 may be fed directly into the sump 22, bypassing the electrochemical capture system 10.

The discharge stream 30 may be directed by valves 40 into the electrochemical capture system 10. The electrochemical capture system 10 may selectively recover the corrosion inhibitor from the discharge stream 30. Alternatively, for example, when corrosion inhibitor is being released from the electrochemical capture system 10 into the makeup stream 32, valves 40 may direct flow of the discharge stream 30 around the electrochemical capture system 10.

In some embodiments, the capture system may be an adsorption-desorption system including at least one membrane. The adsorption-desorption system may be configured to selectively capture corrosion inhibitor by the at least one membrane and/or store or accumulate the corrosion inhibitor, for example, in the at least one membrane. In some embodiments, the at least one membrane may be configured selectively capture the corrosion inhibitor by passing a water stream with the corrosion inhibitor through the at least one membrane on which the corrosion inhibitor is adsorbed. In some embodiments, the at least one membrane may be configured to release the corrosion inhibitor into a water stream passing through the at least one membrane on which the corrosion inhibitor has been adsorbed. The at least one membrane may be a selective membrane, configured to selectively adsorb/desorb a predetermined capture target. A membrane may be utilized or determined, for example, based on its ability to capture/release a predetermined capture target, for example, at a predetermined pH or temperature, such as at a pH or temperature of the water stream. The at least one membrane may be, for example, but is not limited to a resin membrane, a polymeric membrane, a polymer-ceramic membrane, an electrospun nanofiber membrane, or a membrane formed with the incorporation of a nanomaterial. The adsorption-desorption system may be used in conjunction with or in place of another capture system, for example the electrochemical capture system 10, to selectively capture and/or release a capture target. [Please confirm our understanding of the adsorption-desorption system is correct].

In some embodiments, the capture system may be a chemical precipitation and dissolution system. The chemical precipitation and dissolution system may be configured to selectively capture a corrosion inhibitor by the addition of, for example, a predetermined precipitant or release or selectively release the capture target, for example, with the addition of a predetermined dissolution reagent. The chemical precipitation and dissolution system may apply at least one predetermined precipitant for a predetermined amount of time to the water stream to precipitate the capture target. The capture target may then be removed from the water stream, for example by a known method including filtration, centrifugation, or sedimentation. Similarly, the chemical precipitation and dissolution system may apply at least one predetermined dissolution agent for a predetermined amount of time to the water stream, including the precipitant, to dissolve the capture target and recycle the capture target into the water stream. The predetermined precipitant and/or the predetermined dissolution agent may be configured to selectively precipitate or dissolve a capture target, for example, at a predetermined pH or temperature, such as at a pH or temperature of the water stream. The chemical precipitation and dissolution system may be a multi-stage chemical precipitation and dissolution system. For example, in precipitating or dissolving the capture target, a first stage may be utilized in which a predetermined amount of precipitant or dissolution agent is added for a predetermined amount of time until a target percentage of the capture target is precipitated or dissolved. A next stage may then be utilized in which a predetermined amount of precipitant or dissolution agent is added for a predetermined amount of time until a next target percentage of a next capture target is precipitated or dissolved. Any amount of stages may be utilized in either precipitation or dissolution of the capture target. The chemical precipitation and dissolution system may be used in conjunction with or in place of another capture system, for example the electrochemical capture system 10, to selectively capture and/or release a capture target. [Please confirm our understanding of the chemical precipitation and dissolution system is correct].

### Method of Recovery and Recycling

### Recovery of the Corrosion Inhibitor

In the electrochemical capture system 10, a treatment voltage may be applied to change the oxidation state of a capture target to capture the target. For example, a first voltage may be determined and applied to the electrochemical capture system 10 by the electrochemical cell 14. The first voltage may be determined, for example, by an oxidation reduction potential associated with the corrosion inhibitor to be selectively recovered, i.e. the capture target. For example, an oxidation reduction potential of the capture target may be determined by a Pourbaix diagram at a predetermined pH. The predetermined pH may correspond to a measured or determined pH of the process stream at the capture site, such as at the discharge stream 30. The determined first voltage may then be applied to the electrochemical capture system 10. The first voltage may cause the capture target to precipitate into a more capturable form. For example, tin may be provided in a soluble form in the corrosion inhibitor treatment, such as Tin(II). The application of the first voltage at a determined oxidation reduction potential may alter Tin(II) in the electrochemical capture system 10 to Tin(IV), thereby decreasing the solubility of tin and causing the tin to precipitate. In another embodiment, Tin(II) and/or Tin(IV) may be soluble in a solution and the application of the first voltage may alter Tin(II) and/or Tin(IV) to Tin(s), causing the tin to precipitate. The precipitated tin may then be captured.

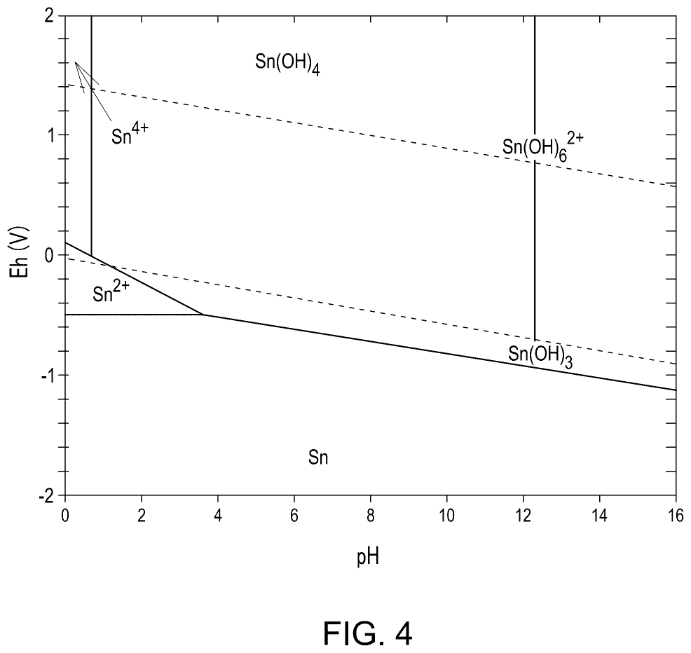

Table 1 below provides standard electrode potentials, i.e. oxidation reduction potentials, for various components as an example. Table 1 is provided from http://hyperphysics.phy-astr.gsu.edu/hbase/Tables/electpot.html, as accessed on Jul. 10, 2024. The voltages provided in Table 1 may be applied to the electrochemical capture system 10, for example, to capture a specific capture target. For example, a first voltage of −0.14 volts may be applied to the electrochemical capture system 10 to change the oxidation state of Tin(II) into Tin(s) and the Tin(s) may then be captured. The electrode potentials of Table 1 are determined at an aqueous solution at 25° C. and may vary, for example, with respect to temperature and pH, as demonstrated in FIG. 4 and described in more detail below. An electrode potential table, such as Table 1, may be consulted by, for example, a control system or a user, to determine a treatment voltage.

TABLE 1
Standard Electrode Potentials in Aqueous Solution at 25° C.

| | Standard |
|---|---|
| | Potential |
| Cathode (Reduction) Half-Reaction | E° (volts) |
| Li⁺(aq) + e⁻ −> Li(s) | −3.04 |
| K⁺(aq) + e⁻ −> K(s) | −2.92 |
| Ca²⁺(aq) + 2e⁻ −> Ca(s) | −2.76 |
| Na⁺(aq) + e⁻ −> Na(s) | −2.71 |
| Mg²⁺(aq) + 2e⁻ −> Mg(s) | −2.38 |
| Al³⁺(aq) + 3e⁻ −> Al(s) | −1.66 |
| 2H₂O(l) + 2e⁻ −> H₂(g) + 2OH⁻(aq) | −0.83 |
| Zn²⁺(aq) + 2e⁻ −> Zn(s) | −0.76 |
| Cr³⁺(aq) + 3e⁻ −> Cr(s) | −0.74 |
| Fe²⁺(aq) + 2e⁻ −> Fe(s) | −0.41 |
| Cd²⁺(aq) + 2e⁻ −> Cd(s) | −0.40 |
| Ni²⁺(aq) + 2e⁻ −> Ni(s) | −0.23 |
| Sn²⁺(aq) + 2e⁻ −> Sn(s) | −0.14 |
| Pb²⁺(aq) + 2e⁻ −> Pb(s) | −0.13 |
| Fe³⁺(aq) + 3e⁻ −> Fe(s) | −0.04 |
| 2H⁺(aq) + 2e⁻ −> H₂(g) | 0.00 |
| Sn⁴⁺(aq) + 2e⁻ −> Sn²⁺(aq) | 0.15 |
| Cu²⁺(aq) + e⁻ −> Cu⁺(aq) | 0.16 |
| ClO₄⁻(aq) + H₂O(l) + 2e⁻ −> ClO₃⁻(aq) + 2OH⁻(aq) | 0.17 |
| AgCl(s) + e⁻ −> Ag(s) + Cl⁻(aq) | 0.22 |
| Cu²⁺(aq) + 2e⁻ −> Cu(s) | 0.34 |
| ClO₃⁻(aq) + H₂O(l) + 2e⁻ −> ClO₂⁻(aq) + 2OH⁻(aq) | 0.35 |
| IO⁻(aq) + H₂O(l) + 2e⁻ −> I⁻(aq) + 2OH⁻(aq) | 0.49 |
| Cu⁺(aq) + e⁻ −> Cu(s) | 0.52 |
| I₂(s) + 2e⁻ −> 2I⁻(aq) | 0.54 |
| ClO₂⁻(aq) + H₂O(l) + 2e⁻ −> ClO⁻(aq) + 2OH⁻(aq) | 0.59 |
| Fe³⁺(aq) + e⁻ −> Fe²⁺(aq) | 0.77 |
| Hg₂²⁺(aq) + 2e⁻ −> 2Hg(l) | 0.80 |
| Ag⁺(aq) + e⁻ −> Ag(s) | 0.80 |
| Hg²⁺(aq) + 2e⁻ −> Hg(l) | 0.85 |
| ClO⁻(aq) + H₂O(l) + 2e⁻ −> Cl⁻(aq) + 2OH⁻(aq) | 0.90 |
| 2Hg²⁺(aq) + 2e⁻ −> Hg₂²⁺(aq) | 0.90 |
| NO₃⁻(aq) + 4H⁺(aq) + 3e⁻ −> NO(g) + 2H₂O(l) | 0.96 |
| Br₂(l) + 2e⁻ −> 2Br⁻(aq) | 1.07 |
| O₂(g) + 4H⁺(aq) + 4e⁻ −> 2H₂O(l) | 1.23 |
| Cr₂O₇²⁻(aq) + 14H⁺(aq) + 6e⁻ −> | 1.33 |
| 2Cr³⁺(aq) + 7H₂O(l) | |
| Cl₂(g) + 2e⁻ −> 2Cl⁻(aq) | 1.36 |
| Ce⁴⁺(aq) + e⁻ −> Ce³⁺(aq) | 1.44 |
| MnO₄⁻(aq) + 8H⁺(aq) + 5e⁻ −> Mn²⁺(aq) + 4H₂O(l) | 1.49 |
| H₂O₂(aq) + 2H⁺(aq) + 2e⁻ −> 2H₂O(l) | 1.78 |
| Co³⁺(aq) + e⁻ −> Co²⁺(aq) | 1.82 |
| S₂O₈²⁻(aq) + 2e⁻ −> 2SO₄²⁻(aq) | 2.01 |
| O₃(g) + 2H⁺(aq) + 2e⁻ −> O₂(g) + H₂O(l) | 2.07 |
| F₂(g) + 2e⁻ −> 2F⁻(aq) | 2.87 |

FIG. 4 is an example of a Pourbaix diagram for Sn—H₂O at 25° C. FIG. 4 is provided from https://www.researchgate.net/figure/Pourbaix-E-pH-maps-for-Sn—H2O-systems-at-25C_fig2_350829658, as accessed on Jul. 10, 2024. As shown in FIG. 4, a voltage, for example to change the oxidation state of a target, may vary with respect to the pH of the water stream. Accordingly, an appropriate voltage may be determined based on, for example, a pH and a Pourbaix diagram. A specific Pourbaix diagram may vary, for example, with respect to a specific capture target and a temperature of the water stream. A Pourbaix diagram, such as in FIG. 4, may be consulted by, for example a control system or a user, to determine a treatment voltage after determining pH.

In some embodiments, the electrochemical capture system 10 may capture the capture target by electroplating. In such an embodiment, an electroplating voltage applied to the electrochemical capture system 10 by the electrochemical cell 14 may cause the capture target to deposit on at least one electrode 12 of the electrochemical capture system 10. The electroplating voltage may be the first voltage.

In some embodiments, the electrochemical capture system 10 may precipitate the capture the capture target and then capture the capture target by, for example, metal scavenger chemistry, adsorption through selective resin, activated carbon, clay, filtration, sedimentation and decantation, evaporation, or distillation.

### Recycle of the Corrosion Inhibitor

Once captured, the capture target may be recycled, released, or discharged into the cooling water treatment system 100. For example, the captured target may be recycled into the water treatment system 100 at a re-injection site. However, the captured target need not be recycled into the water treatment system 100, and the captured target may be removed from the water treatment system 100 by, for example, removal/replacement of the at least one electrode 12 of the electrochemical capture system 10.

In some embodiments, the at least one electrode 12 of the electrochemical capture system 10 or the entirety of the electrochemical capture system 10 may be removed from the capture site. In some embodiments, the at least one electrode 12 of the electrochemical capture system 10 or the entirety of the electrochemical capture system 10 may be repositioned at the re-injection site for releasing the capture target into the cooling water treatment system 100. For example, the corrosion inhibitor may be reintroduced into the water treatment system 100 at the corrosion inhibitor feed supply.

In some embodiments, the captured corrosion inhibitor may be released into the makeup stream 32, and the re-injection site is the same as the capture site. In such an embodiment, the capture site may become the re-injection site by activation of the valves 40. For example, the captured target may be released into the makeup stream 32 and then discharged from the electrochemical capture system 10 into the water treatment system 100, for example into the sump 22. In some embodiments, the makeup stream 32 may continuously flow through the electrochemical capture system 10. Upon completion of recycling the capture target into the water treatment system 100, the valves 40 may be activated, positioning the electrochemical capture system 10 from the makeup stream 32 to the discharge stream 30, for re-capture to the corrosion inhibitor.

To recycle the capture target into the cooling water treatment system 100, a treatment voltage may be applied to change the oxidation state of a release target to release the target from the at least one electrode 12. For example, a second voltage may be applied to the electrochemical capture system 10. The second voltage may be the reverse of the first voltage applied during the capture of the capture target, i.e., the polarity of the first voltage may be reversed resulting in the second voltage. For example, as shown in Table 1, a first voltage to change the oxidation state of Tin(II) to Tin(s) may be −0.14. Thus, a second voltage to change the oxidation state of Tin(s) to Tin(II) may be 0.14.

Alternatively, the second voltage may be determined and applied to the electrochemical capture system 10 when the electrochemical capture system 10 is in fluid communication with the makeup stream 32. The second voltage may be determined, for example, by an oxidation reduction potential associated with the capture target. For example, an oxidation reduction potential of the capture target may be determined by a Pourbaix diagram at a predetermined pH. The predetermined pH may correspond to a measured or determined pH at the re-injection site, i.e. where the electrochemical capture system 10 is in contact with the makeup stream 32. The determined second voltage may then be applied to the electrochemical capture system 10 by the electrochemical cell 14. The second voltage may cause the capture target to increase its solubility and dissolve into the makeup stream 32. For example, the second voltage applied may alter Tin(IV) into Tin(II) which dissolves into the makeup stream 32 for reapplication as a corrosion inhibitor in the cooling water treatment system 100. In another embodiment, the second voltage may alter Tin(s) to Tin(II) and/or Tin(IV), dissolving the tin into the makeup stream 32.

An appropriate voltage may be determined based on, for example, a pH and a Pourbaix diagram. Accordingly, a Pourbaix diagram, such as in FIG. 4, may be consulted by, for example a control system or a user, to determine a treatment voltage for release and recycle of the capture target after determining a pH.

In some embodiments, the recycled capture target may supply the entirety of the corrosion inhibitor treatment. In other embodiments, for example, the recycled capture target may not adequately meet a baseline demand of the system to ensure treatment of vulnerable metal surfaces. Accordingly, additional corrosion inhibitor treatment or components thereof may be added with the recycled capture target. In some embodiments, the additional corrosion inhibitor treatment may be added to the water treatment system 100 with the capture target, for example, when recycling the capture target into water treatment system 100. The additional corrosion inhibitor treatment may also be added separately, for example, at a different position and/or at a different time than the capture target during recycling of the capture target.

### The Corrosion Inhibitor

The corrosion inhibitor treatment may include Tin(II) or other metals such as zinc, molybdenum, copper, and aluminum. The corrosion inhibitor treatment may further comprise a reducing agent, a secondary corrosion inhibitor treatment, and/or a chelating agent. The corrosion inhibitor treatment may further include other materials. For example, the treatment may comprise, at least one of citric acid, benzotriazole and 2-Butenedioic acid (Z), bicarbonates for increasing the alkalinity of the solution, a polymeric dispersant, such as 2-acrylamido-2-methylpropane sulfonic acid (AMPS), for inhibiting silt or fouling, and polymaleic acid (PMA) for inhibiting scaling. The corrosion inhibitor treatment may include, for example, ChemTreat FlexPro™ CL5632 (a phosphorous-free and zinc-free corrosion treatment), manufactured by ChemTreat, Inc., or the like.

A concentration of the corrosion inhibitor, such as Tin(II), in the water stream may be in the range of 0.01 ppm to 3 ppm, 0.05 ppm to 2 ppm, 0.1 ppm to 1.5 ppm, or 0.3 ppm to 1.25 ppm. However, the concentration of the corrosion inhibitor may be higher, for example, to exceed a baseline demand of the system and thereby ensure treatment of vulnerable metal surfaces, resulting in excess corrosion inhibitor.

The corrosion inhibitor treatment may be provided in an aqueous solution. The corrosion inhibitor in the aqueous solution may be present in an amount in the range of 0.01 to 50 wt %, 0.1 to 35 wt %, or 1 to 25 wt % or 10 to 20 wt %, in terms of total weight of the corrosion inhibitor treatment and the aqueous solution.

In another embodiment, the corrosion inhibitor treatment may be provided in a shot/slug feed application, where a high concentration is fed over a short period of time. For example, in a shot/slug feed application, a concentration of the corrosion inhibitor treatment in the water stream may be in the range of 50 to 500 ppm, 100 to 300 ppm, or 150 to 250 ppm. A concentration of the corrosion inhibitor, such as Tin(II), in the water stream during a shot dose treatment may be in the range of 0.1 to 1000 ppm, 0.2 ppm to 50 ppm, or 0.5 to 10 ppm.

### Control System

A control system may control the electrochemical cell 14 of the electrochemical capture system 10. The control system may, for example, be configured to determine a voltage and then control the electrochemical cell 14 to apply the predetermined voltage to the electrochemical capture system 10. The determined voltage may correspond to a treatment voltage or an electroplating voltage. For example, to selectively capture or release a capture target, the controller may acquire or determine a pH of the fluid in the electrochemical capture system 10 and determine a voltage corresponding to the pH and the capture target by way of a Pourbaix diagram, an oxidation reduction potential table, or a memory configured to supply corresponding voltages. The controller may then apply the voltage to the electrochemical capture system 10 to selectively capture the capture target or release the capture target.

The control system may be automated by way of a controller, such as a processor or CPU, which receives signals indicating a measured parameter, such as pH, calculates or determines a voltage, and sends a signal to electrochemical cell 14 to apply the voltage. In some embodiments, the control system may be manually operated.

The control system may further control the valves 40. For example, the valves 40 may be operated simultaneously such that flow is directed through the electrochemical capture system 10 from the makeup stream 32 as flow is diverted from the discharge stream 30 around the electrochemical capture system 10 or vise-versa. In some embodiments, the controller may activate the valves 40 upon determining a capacity or amount of corrosion inhibitor in the electrochemical capture system 10. For example, a sensor may determine an amount of corrosion inhibitor recovered by the electrochemical capture system 10. When the amount of corrosion inhibitor recovered exceeds a target capacity or amount, the controller may activate the valves 40 redirecting flow of the discharge stream 30 around the electrochemical capture system 10 and directing flow of the makeup stream 32 through the electrochemical capture system 10. Alternatively, a sensor may detect an amount of corrosion inhibitor remaining in the electrochemical capture system 10. When the amount of corrosion inhibitor remaining in the electrochemical capture system 10 exceeds target capacity or amount, the controller may activate the valves 40, redirecting flow of the makeup stream 32 around the electrochemical capture system 10 and directing flow of the discharge stream 30 through the electrochemical capture system 10.

In some embodiments, multiple electrochemical capture systems may be utilized. For example, multiple electrochemical capture systems may be used at a time of capture or at a time of release of the capture target. Accordingly, electrochemical capture systems may alternate between capturing and releasing the capture target. Any number of electrochemical capture systems may be utilized.

For example, a first electrochemical capture system may release and recycle the capture target into the cooling water treatment system 100 at the makeup stream 32. Simultaneously, a second electrochemical capture system capture may capture the capture target downstream of the first electrochemical capture system at the discharge stream 30. Valves 40 may reposition the flow of the discharge stream 30 around the second electrochemical capture system and reposition the flow of the makeup stream 32 through the second electrochemical capture system when a target capacity of the second electrochemical capture system is exceeded, i.e. when the second electrochemical capture system is unable to effectively capture additional corrosion inhibitor. Valves 40 may also reposition the flow of the makeup stream 32 around the first electrochemical capture system and a flow of the discharge stream 30 through the first electrochemical capture system when a target capacity of the first electrochemical capture system is exceeded, i.e. when the first electrochemical capture system has effectively released all captured corrosion inhibitor.

It will be appreciated that the above-disclosed features and functions, or alternatives thereof, may be desirably combined into different methods and systems. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for recovering a corrosion inhibitor from a water system, the method comprising:
treating a water stream of the water system that includes the corrosion inhibitor to selectively recover the corrosion inhibitor from the water stream.

2. The method according to claim 1, further comprising introducing the recovered corrosion inhibitor back into the water system.

3. The method according to claim 2, wherein the water stream is a discharge stream, and the recovered corrosion inhibitor is introduced into a feedwater stream of the water system.

4. The method according to claim 1, wherein the water stream is blowdown from a cooling water tower.

5. The method according to claim 1, wherein the corrosion inhibitor is selectively recovered by treating the water stream in an electrochemical system including at least one electrode.

6. The method according to claim 5, wherein the corrosion inhibitor is selectively recovered by applying a predetermined voltage to the electrochemical system to change an oxidation state of the corrosion inhibitor, the predetermined voltage corresponding to an oxidation reduction potential of the corrosion inhibitor.

7. The method according to claim 6, wherein the corrosion inhibitor is precipitated on the at least one electrode by applying the predetermined voltage.

8. The method according to claim 6, further comprising:
discharging the water stream from the electrochemical system after recovering the corrosion inhibitor,
introducing a feedwater stream into the electrochemical system after the water stream has been discharged from the electrochemical system, and
releasing the recovered corrosion inhibitor into the feedwater stream.

9. The method according to claim 8, wherein recovered corrosion inhibitor is released into the feedwater stream by reversing a polarity of the at least one electrode and applying the predetermined voltage to the electrode.

10. The method according to claim 8, further comprising introducing the feedwater stream into the water system after releasing the recovered corrosion inhibitor.

11. The method according to claim 1, wherein the corrosion inhibitor is at least one of tin, zinc, molybdenum, copper, and aluminum.

12. The method according to claim 6, wherein the corrosion inhibitor is tin and the tin is recovered by applying a predetermined voltage to the electrochemical system to change an oxidation state of the tin from Tin(II) or Tin(IV) to Tin(s).

13. The method according to claim 1, wherein the corrosion inhibitor is selectively recovered by treating the water stream in an adsorption-desorption system in which the water stream is passed through at least one membrane on which the corrosion inhibitor is adsorbed.

14. The method according to claim 1, wherein the corrosion inhibitor is selectively recovered by treating the water stream in a chemical precipitation and dissolution system in which at least one precipitant is added to the water stream to precipitate the corrosion inhibitor.

15. A water system comprising:
at least one conduit through which a discharge stream flows, wherein the discharge stream is a water stream that has been treated with a corrosion inhibitor; and
a corrosion inhibitor recovery system configured to:
receive the discharge stream from the at least one conduit, and
selectively recover the corrosion inhibitor from the discharge stream.

16. The water system of claim 15, further comprising
at least one conduit through which a feedwater stream flows, wherein the feedwater stream is a water stream that has not been treated with the corrosion inhibitor, and
wherein the corrosion inhibitor recovery system is further configured to:
receive the feedwater stream from the at least one conduit, and
release the recovered corrosion inhibitor into the feedwater stream.

17. The water system of claim 16, further comprising:
a first valve configured to regulate fluid communication between the corrosion inhibitor recovery system and the at least one conduit through which the discharge stream flows, and
a second valve configured to regulate fluid communication between the corrosion inhibitor recovery system and the at least one conduit through which the feedwater stream flows.

18. The water system of claim 15, wherein the corrosion inhibitor recovery system comprises an electrochemical system including at least one electrode.

19. The water system of claim 18, further comprising a controller configured to determine a treatment voltage and control an electrochemical cell to apply the treatment voltage to the electrochemical system.

20. The water system of claim 15, further comprising a cooling water tower,
wherein blowdown from the cooling water tower is the discharge stream.
